(19) United States
(12) Patent Application Publication
(10) Pub. No.: US 2015/0128288 A1
(43) Pub. Date: May 7, 2015

(54) Private photograph storage in digital camera user interface

(71) Applicant: Jeremy Nicholas Yablan, Simi Valley, CA (US)

(72) Inventor: Jeremy Nicholas Yablan, Simi Valley, CA (US)

(21) Appl. No.: 14/588,963

(22) Filed: Jan. 4, 2015

(51) Int. Cl. G06F 21/60

(52) U.S. Cl. CPC G06F 21/60
USPC 726/27

(57) ABSTRACT

This invention relates in general to a digital information/imaging system such as a digital camera which captures and processes an image for immediate or future viewing, and more particular to a digital information/imaging system having an immediate switch for quickly routing subsequent photos into a separate secured area.

### SUMMARY OF THE INVENTION

According to the present invention, there is a solution to the problem which is not currently covered by the prior art. According to the feature of the present invention, there is a method of user interface which will quickly switch the storage method without heavy navigation.

### ADVANTAGEOUS AFFECT OF INVENTION

1. Securing photos, videos, or other information in case device is lost or stolen.
2. Securing images containing information which may be secret or containing data which needs to be hidden due to commercial or governmental secrecy contracts or other privacy issues.
3. Securing images which may be considered indecent or nude, or may be though inappropriate to be shared publicly or with children.
4. Storing images not wanted in the main filing area in an alternate area.

### BACKGROUND OF THE INVENTION

Handheld digital information/imaging systems, such as digital cameras, cell phones, computers or portable computers, laptop computers, tablets, PDAs or personal digital assistants, and also wearable technology such as digital watches and eyewear, game consoles, and portable gaming systems have become increasingly used for capturing still photography and motion videography for personal and commercial use.

These devices usually include a display for viewing images or information useful to the user. There are many methods to providing the display including LCD, LED, OLED, resistive touchscreen, surface acoustic wave, super AMOLED, capacitive resistance, surface capacitance, projected capacitance, PCT, PCAT, mutual capacitance, self-capacitance, infrared grid, infrared acrylic projection, optical imaging, dispersive signal technology, acoustic pulse recognition, and many others. Display may also be provided on a “heads up” display on eyewear or similar technology.

The display can also display image capture related functions and menus of camera features that are user selectable (See: U.S. patent application Publication U.S. Ser. No. 2002/0030754 A1, published Mar. 14, 2002, inventor Sugimoto; U.S. patent application Publication U.S. Ser. No. 2002/0024604 A1, published Feb. 28, 2002, inventors Fjima et al.; U.S. patent application Publication U.S. Ser. No. 2002/0057351 A1, published May 16, 2002, inventors Suzuki et al.; U.S. Pat. No. 6,313,877 B1, issued Nov. 6, 2001, inventor Anderson; U.S. patent application Publication U.S. Pat. No. 7,827,508 B2, issued Nov. 2, 2010, inventor Michael Venturino).

Navigation may be provided by navigation pad, buttons, touch screen, scroll wheel, motion, image recognition, voice, or any other method.

These devices are generally shared with children, friends, and other family members. These images are often saved to cloud storage where they can then be viewed on other devices. These shared images then can be displayed as screen savers on other devices such as television multimedia players and laptops automatically.

It would be highly desirable when capturing images inappropriate for publicly sharing if there was a simple switch to save such images to a separate secured area where it can only be accessed by the creator.

### BRIEF DESCRIPTION OF DRAWINGS

FIG. 1 shows a potential configuration of a digital camera with a display and several possible navigation methods.

FIG. 2 shows a possible cell phone/tablet configuration with display and several possible navigation methods.

FIG. 3 shows a possible wristwatch configuration with display and several possible navigation methods.

FIG. 4 shows a possible eyewear configuration with display and several possible navigation methods.

FIG. 5 shows a possible mode selection block diagram.

FIG. 6 shows a possible mode settings block diagram.

FIG. 7 shows a possible “presently filed” set of image options block diagram.

### DETAILED DESCRIPTION OF THE INVENTION

The following invention is for the quick change of photo or video storage from public to private on any electronic device. This includes digital cameras, cell phones, tablets, computers or portable computers, game consoles or portable gaming systems, PDAs or personal assistants, wearable or wrist or eyewear devices, or any other devices performing a similar function.

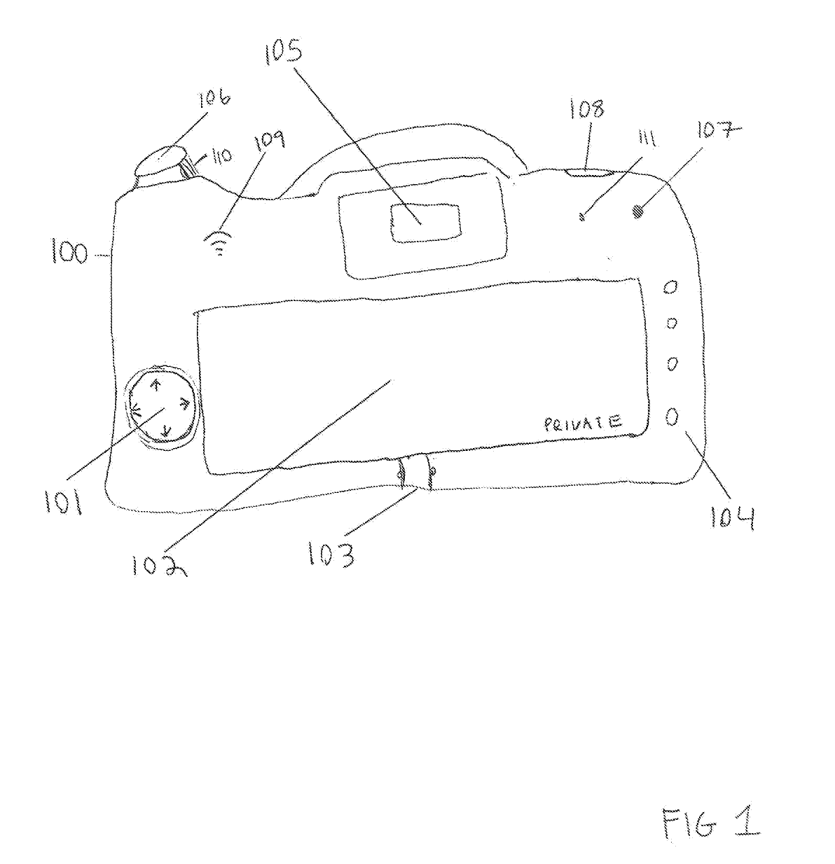

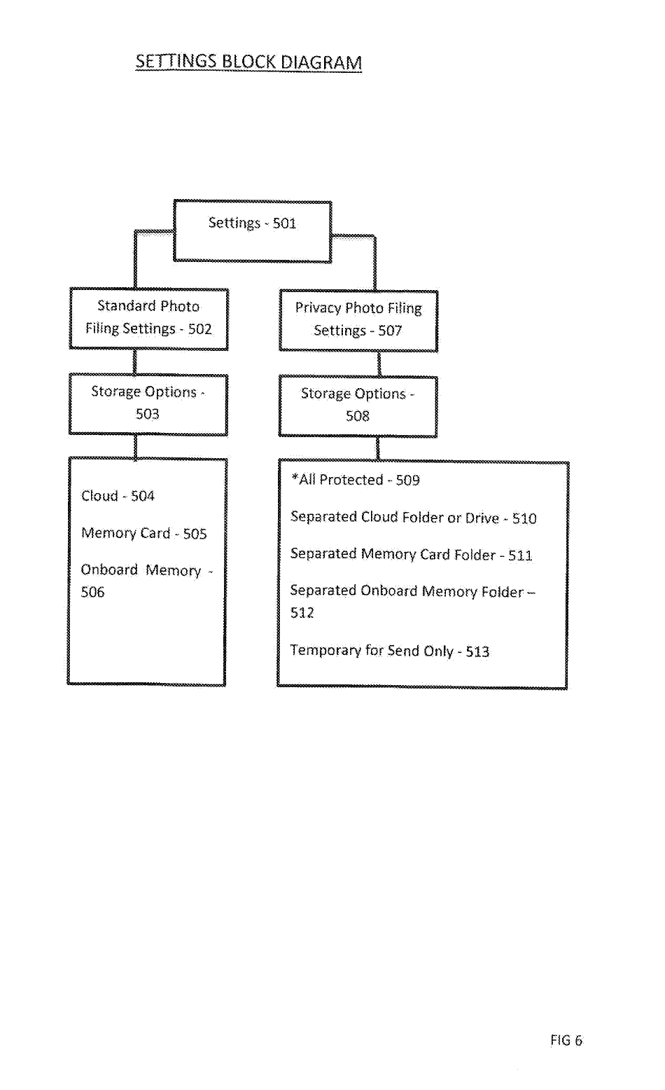

FIG. 1 shows the possible configuration on a digital camera 100. Ideally, when viewing an image for capture through either the viewfinder 105 or on the digital display 102 there would be an option on the screen labeled “private” or “private mode” or “privacy” or “private mode” or “protected” or “protected mode” or “alt storage” or any other symbol or icon or variation which tells the operator this will switch to the private mode storage area as defined in the private mode storage settings as shown on FIG. 6 when activated. After touching the “private” icon on the display, it would then change appearance becoming highlighted or brighter or selected in some way to give feedback indicating selection of the mode has been successful. Once activated, subsequent photos or videos taken with the device will be redirected to a separate protected folder which can only be accessed by the owner with the security of his or her choice and the data should be encrypted.

Methods of securing said photo or video can include a password, fingerprint, or otherwise protected folder on a cloud account accessed by wireless 109, separated folder located in the onboard memory, separated folder located on removable memory card 108, or any other means of separation of memory location available to the device.

Other possible methods of navigation could include scroll wheel 110 and button 106, voice activation through a microphone 107, movement via motion or camera sensor 111, navigation pad 101, or button array 104 whether configurable or fixed. The device would remain in this protected mode until the privacy icon has been deselected. Deselection would remove the visual indication of activation and the device would return to standard mode. Subsequent photos or videos taken would resume filing in the standard filing area as defined in FIG. 6.

This method is the basis for all designs in this invention. These diagrams show some possible deviations in design due to device differences. The basic method remains the same.

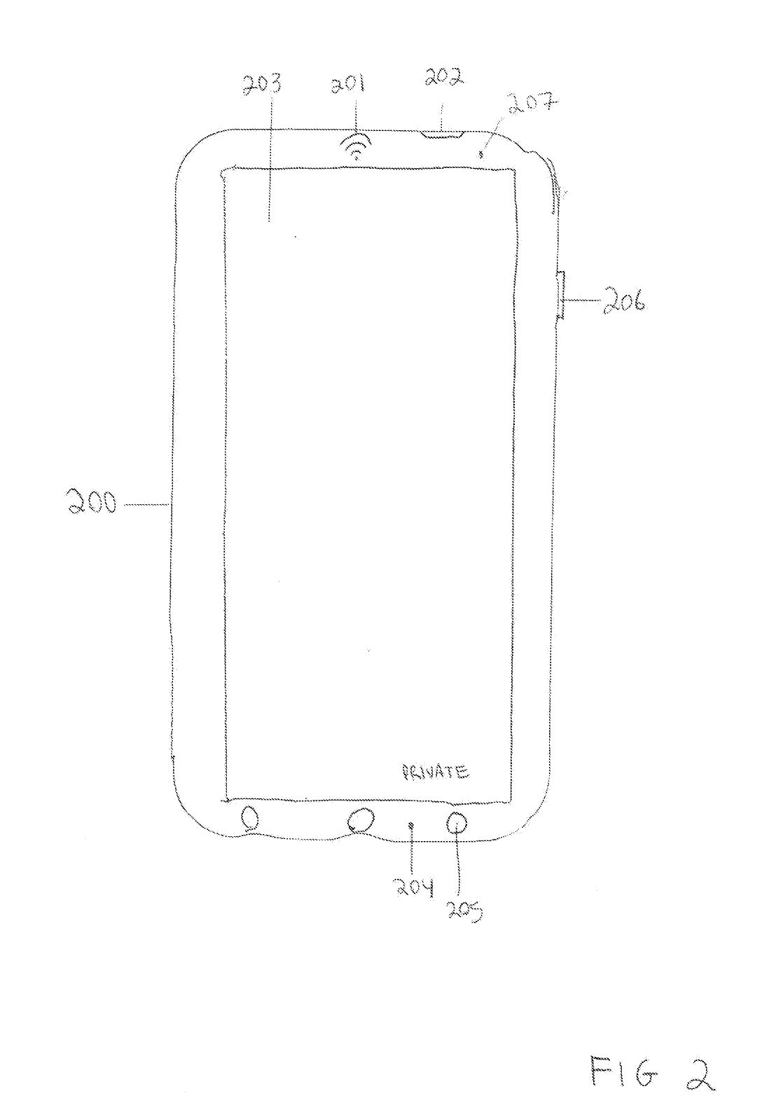

FIG. 2 shows a possible configuration on a smartphone, cellphone, tablet, or other touchscreen portable device 200. It uses the same touchscreen navigation as 100 shown as 203, and can also use buttons 205, 206 or voice 204, or motion 207, or similar activation techniques. Data can also be stored onboard, remotely in a cloud storage via wireless 201, or on removable storage 202, or any other means of storage available and also configurable in the settings FIG. 6.

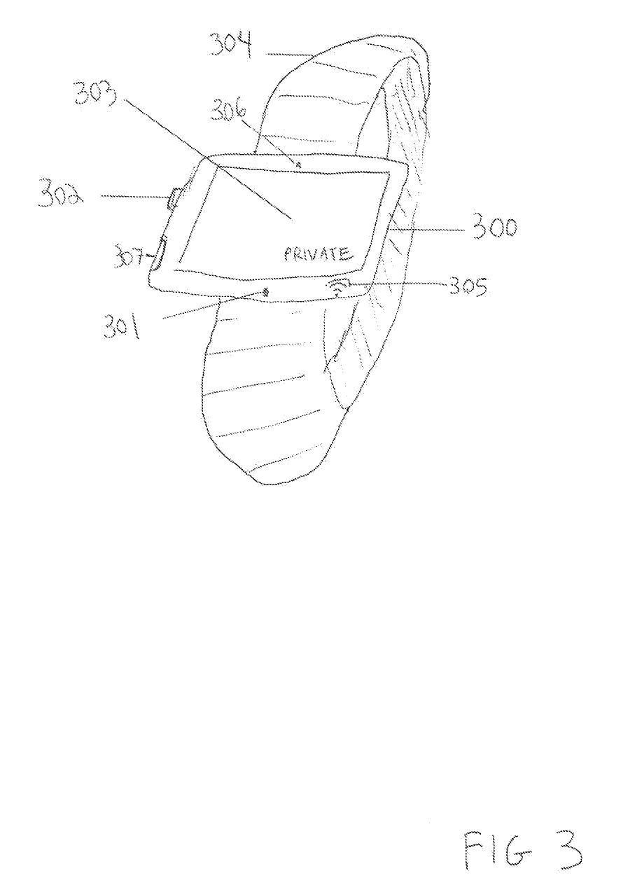

FIG. 3 shows a possible configuration on a wrist wearable device 300 which would attach with a band or strap 304. It would also have a display or touch screen 303. The device may be independent and contain a camera 306 for capturing photographs or motion video or it may also be used as a remote control for another device. There may be removable storage 307 or onboard storage where the remote device can save data to. There may also be motion sensors integrated which could activate privacy mode at the flick of the wrist or any other predetermined motions. It may be activated by voice via speaker 301 or by pressing a simple privacy button 302. This device would also send photos to a separate protected location configurable as in FIG. 6 when privacy mode is activated.

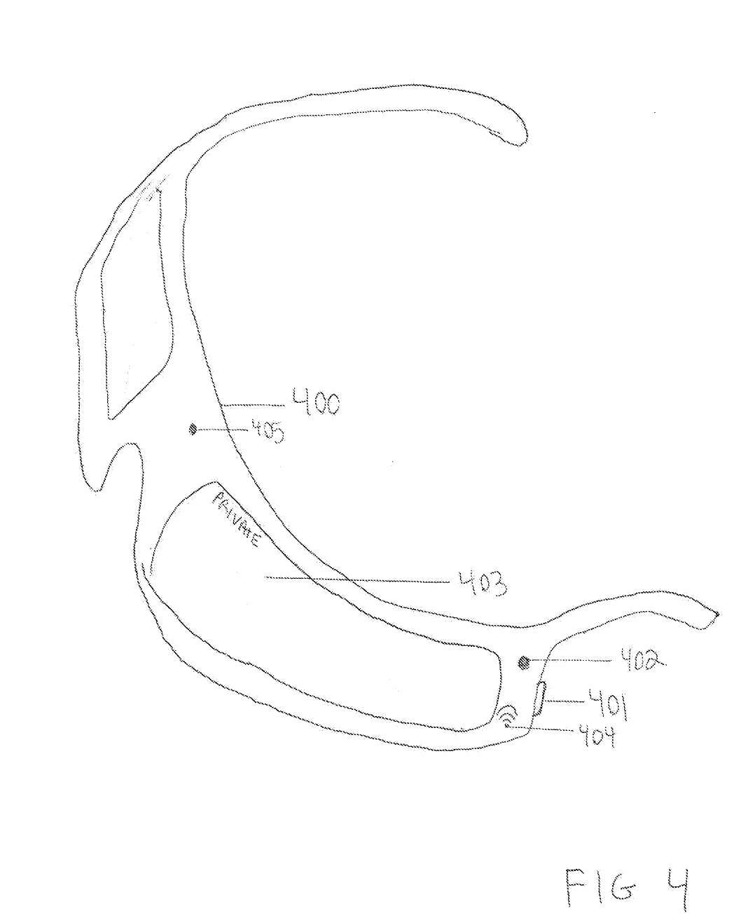

FIG. 4 shows a possible configuration for a wearable eyewear device 400. This version would have similar features to the wearable wrist version FIG. 3. Programmable head motions could be used via motion sensors to activate privacy mode. Also certain hand motions can be programmed to activate privacy mode, or simply the recognition of certain programmed objects via the camera 405 (naked breast for example) would activate privacy mode. Options also include voice activation via microphone 402, specific blink, squint, or glance activation, or a simple privacy button 401. This device could use the same onboard or removable storage as the wrist device FIG. 3 and be used as remote private storage, or could send via wireless 404 connection to storage on another device or remote cloud storage. Privacy is written in reverse on 403 for clarity.

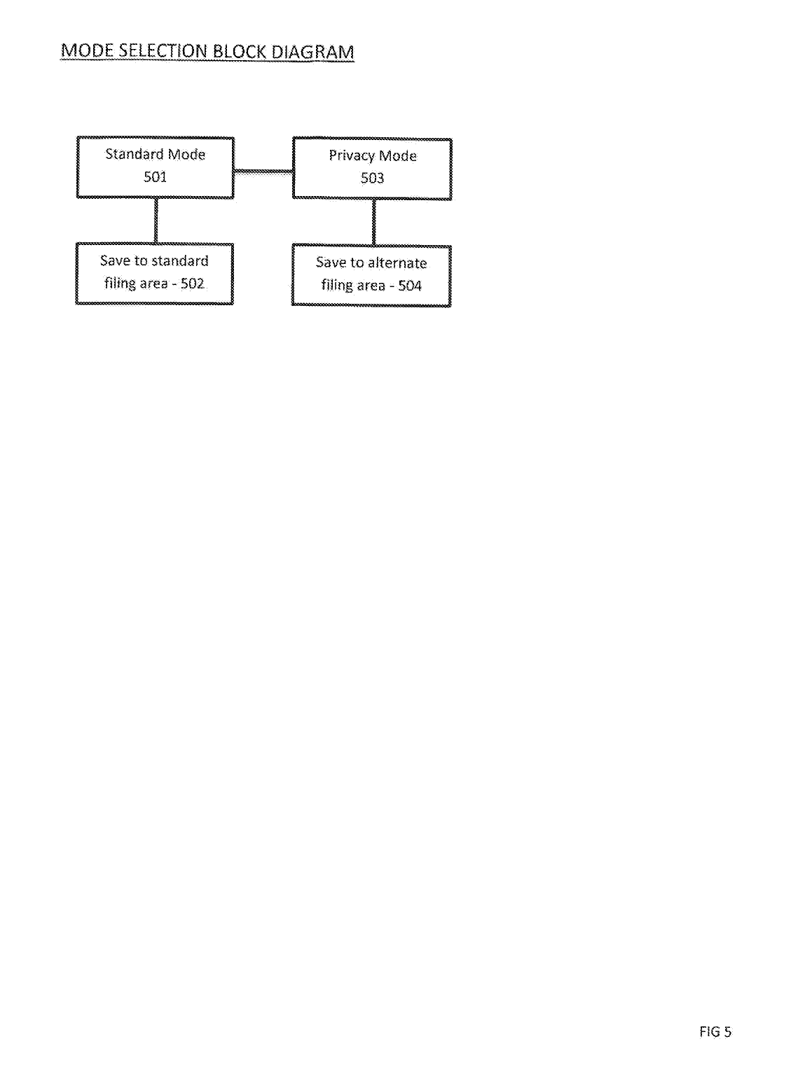

FIG. 5 is a block diagram describing the different modes. Standard Mode 501 would send all photos and videos to the standard destination such as standard cloud storage or standard local storage 502; wherever the users normal filing area would be in the settings. When privacy mode 503 is activated, all photos and videos would be routed to a protected folder 504. This could also be in the cloud or local, but would be separate from the standard modes filing area. Access to these photos or videos in the alternate filing area 504 for viewing would require a password, fingerprint, iris scan, facial scan, or any other user verification method available. If there are multiple users on a device, each user can have a separate protected folder with their own user verification. Each person can only view their own content.

FIG. 6 is a block diagram describing a possible layout for the standard/privacy settings 501. Under the standard photo filing settings 502 there could be storage options 503 which include saving photos and videos to the standard folder in the cloud 504, or on a memory card 505, or on the onboard memory 506. Under the privacy photo filing settings 507, there would be similar storage options 508. All options would include user verification and be protected and encrypted 509. There would be options for saving to a separate protected cloud folder 510, or memory card folder 511, or onboard memory folder 512. There could also be an option for the private photos or videos to be used for sending out only 513. This would pop up a menu with options like text message, email, facebook, etc. and once the item is sent it is removed from the device.

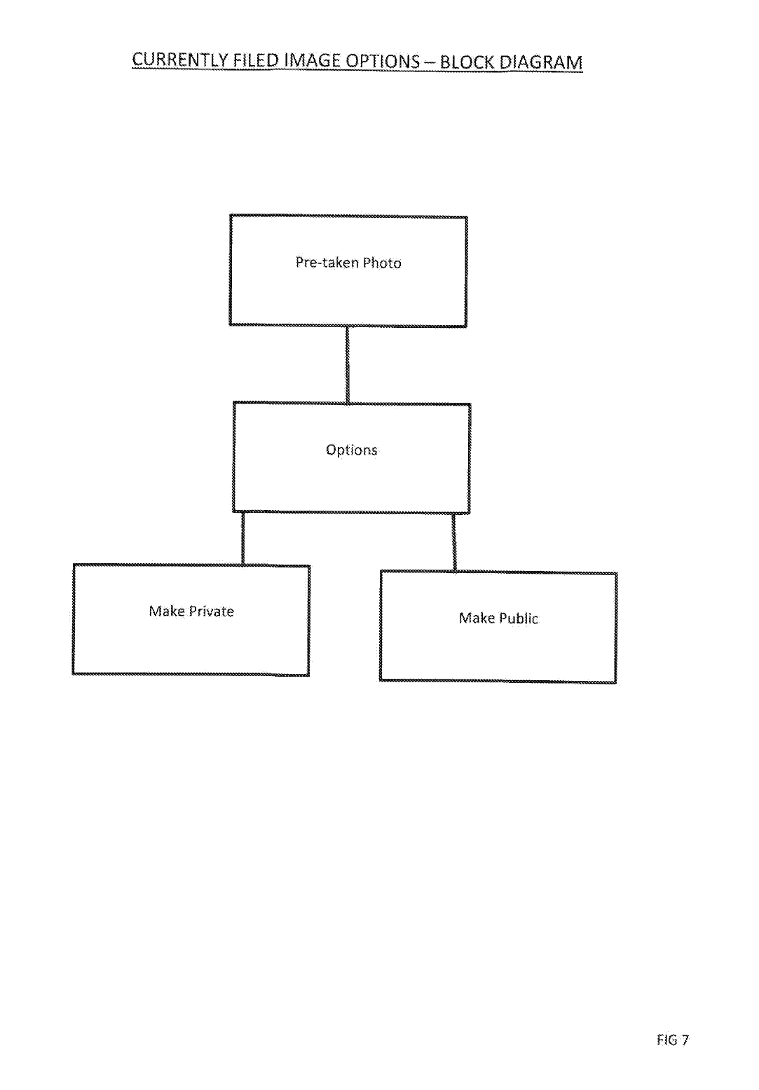

FIG. 7 is a block diagram showing an inclusion of menu items needed for presently filed images. When displaying photos or videos already on the device whether protected or not, the option to move to the opposite folder should exist. For example: after using his fingerprint to view a protected photo the owner decides to make the photo public by selecting the photo options and choosing “make public”. The photo now displays on his television's screen saver and computer's slideshow.

The invention has been described in detail with particular reference to certain preferred embodiments thereof, but it will be understood that variations and modifications can be effected within the spirit and scope of the invention.

### PARTS LIST

100 camera

101 navigation pad

102 display or touch screen

103 hinge

104 buttons

105 view finder

106 privacy button

107 microphone

108 removable storage/memory

109 wireless antenna

110 scroll wheel

111 motion sensor/camera

200 cellphone/smartphone/tablet/touch screen device

201 wireless antenna

202 removable storage/memory

203 display/touch screen

204 microphone

205 buttons

206 button

207 motion sensor/camera

300 wearable device/wrist or ankle

301 microphone

302 privacy button

303 display/touch screen

304 band/strap

305 wireless antenna

306 motion sensor/camera

400 wearable device/eyewear

401 privacy button

402 microphone

403 glasses lens/heads up display

404 wireless antenna

405 motion sensor/camera

PATENT CITATIONS

| Cited | Filing | Publication | | |
|---|---|---|---|---|
| Patent | date | date | Applicant | Title |
| U.S. Pat. No. 4,982,291 | Aug. 23, | Jan. 1, 1991 | Casio Computer | Electronic still video camera capable of searching |
| | 1988 | | Co., Ltd. | desired picture in simple and quick manner |
| U.S. Pat. No. 5,164,831 | Mar. 15, | Nov. 17, 1992 | Eastman Kodak | Electronic still camera providing multi-format |
| | 1990 | | Company | storage of full and reduced resolution images |
| U.S. Pat. No. 5,565,935 | Dec. 5, | Oct. 15, 1996 | Nikon Corporation | Data copying device for a camera |
| | 1994 | | | |
| U.S. Pat. No. 5,610,654 | Mar. 6, | Mar. 11, 1997 | Eastman Kodak | Automatic camera exposure control using variable |
| | 1996 | | Company | exposure index CCD sensor |
| U.S. Pat. No. 5,784,059 | Jun. 30, | Jul. 21, 1998 | Aisin Aw Co., Ltd. | Vehicle navigation system with destination |
| | 1995 | | | selection using hierarchical menu arrangement |
| | | | | with selective level skipping |
| U.S. Pat. No. 5,808,610 | Aug. 28, | Sep. 15, 1998 | Macromedia, Inc. | Method and system of docking panels |
| | 1996 | | | |
| U.S. Pat. No. 6,154,210 | Nov. 25, | Nov. 28, 2000 | Flashpoint | Method and system for implementing button |
| | 1998 | | Technology, Inc. | interface compatibility in touch-screen equipped |
| | | | | digital imaging device |
| U.S. Pat. No. 6,313,877 | Aug. 29, | Nov. 6, 2001 | Flashpoint | Method and system for automatically managing |
| | 1997 | | Technology, Inc. | display formats for a peripheral display coupled to |
| | | | | a digital imaging device |
| U.S. Pat. No. 6,894,718 | May 22, | May 17, 2005 | Pentax | Continual-image processing device for printing or |
| | 2001 | | Corporation | displaying images |
| U.S. Pat. No. 6,952,229 | Apr. 13, | Oct. 4, 2005 | Seiko Epson | Digital camera having input devices and a display |
| | 2000 | | Corporation | capable of displaying a plurality of set information |
| | | | | items |
| US20010043279 | Mar. 2, | Nov. 22, 2001 | Masahito Niikawa | Digital camera |
| | 2001 | | | |
| US20020024604 | Sep. 13, | Feb. 28, 2002 | Nikon Corporation | Information processing apparatus |
| | 2001 | | | |
| US20020030754 | Sep. 7, | Mar. 14, 2002 | Masahiko | Electronic camera |
| | 2001 | | Sugimoto | |
| US20020057351 | May 20, | May 16, 2002 | Masahiro Suzuki | Information input apparatus and method |
| | 1997 | | | |
| US20020123368 | Aug. 20, | Sep. 5, 2002 | Hitoshi Yamadera | Pocket telephone |
| | 2001 | | | |
| US20020145633 | Apr. 24, | Oct. 10, 2002 | Nikon Corporation | Information processing device, method and |
| | 2002 | | | program |
| US20030206239 | May 6, | Nov. 6, 2003 | Battles Amy E. | Menu navigation system and method |
| | 2002 | | | |
| EP1164770A2 | May 31, | Dec. 19, 2001 | Sony Corporation | Portable telephone |
| | 2001 | | | |
| JP2001136418A | | | | Title not available |
| U.S. Pat. No. 7,827,508 B2 | Sep. 13, | Nov. 2, 2010 | Eastman Kodak | Title not available |
| | 2002 | | Company | |

1. Method of changing the storage destination of photos or videos being captured on a device to a secure location.

2. Method of reverting back to the standard storage destination when the secure location of claim 1 is no longer desired.

3. Options needed after implementing claim 1 to transfer data stored between non-secured storage and secured storage.

4. All methods used for activating and deactivating claim 1 on any device including tap, swipe, touch, motion, voice, or button used to change destination of subsequent photos or videos to a secure and private storage area.

5. Settings used to configure the storage and security options of claim 1.

6. All integrations of prior arts for claim 1.
